(19) United States
(12) Patent Application Publication
(10) Pub. No.: US 2008/0111688 A1
(43) Pub. Date: May 15, 2008

(54) METHOD AND APPARATUS TO INCREASE THE RANGE OF RFID SYSTEMS

(76) Inventors: Pavel Nikitin, Seattle, WA (US); Venkata Kodukula, Bothell, WA (US); For Sander Lam, Bothell, WA (US)

Correspondence Address: PERKINS COIE LLP;PATENT-SEA, P.O. BOX 1247, SEATTLE, WA, 98111-1247, US

(21) Appl. No.: 11/558,339

(22) Filed: Nov. 9, 2006

(51) Int. Cl. G08B 13/14

(52) U.S. Cl. 340/572.1

(57) ABSTRACT

Systems and methods for increasing the range of RFID tags are provided. A supplemental RF power source can be provided to energize the tag and increase the distance at which an RFID tag can be read by an RFID reader. In some embodiments, the supplemental power source can be provided at a substantially constant wavelength. In other embodiments, the supplemental power source can be provided by a frequency hopping transmitter or other variable wavelength source.

### BACKGROUND

In the automatic data identification industry, the use of RF transponders (also known as RF tags) has grown in prominence as a way to track data regarding an object on which an RF transponder is affixed. An RF transponder generally includes a semiconductor memory in which information may be stored. An RF interrogator containing a transmitter-receiver unit is used to query (interrogate) an RF transponder that may be at a distance from the interrogator. The RF transponder detects the interrogating signal and transmits a response signal containing encoded data back to the interrogator. RF and RFID systems are used in applications such as inventory management, security access, personnel identification, factory automation, automotive toll debiting, and vehicle identification.

RFID systems can provide certain advantages over conventional optical indicia recognition systems (e.g., bar code symbols). For example, the RF transponders may have a memory capacity of several kilobytes or more, which is substantially greater than the maximum amount of data that may be contained in a conventional one-dimensional bar code symbol. The RF transponder memory may be re-written with new or additional data, which would not be possible with a printed bar code symbol. Moreover, RF transponders may be readable at a distance without requiring a direct line-of-sight view by the interrogator, unlike bar code symbols that must be within a direct line-of-sight and which may be entirely unreadable if the symbol is obscured or damaged. An additional advantage of RFID systems is that several RF transponders can be read by the interrogator at one time.

RFID tags can be read as long as they are within range of a reader. The read/write range of known passive RFID tags is limited. Low-frequency tags are typically read from a foot or less, high frequency tags typically from about three feet, and UHF tags typically from 10 to 20 feet. Typical passive single-port UHF RFID inlays have a maximum range of 20-25 feet, attainable only in ideal free-space conditions with favorable antenna orientation. This is not sufficient for many real-life situations which pose serious challenges for reliable detection and identification of RFID tags. For example, multiple tags may be located in a complex or cluttered RF environment whose dimensions may exceed the read range of an individual tag.

Where longer ranges are needed, such as for tracking railway cars, active tags can use batteries to boost read ranges to 300 feet or more. While using a battery can extend the range of an RFID tag, but this is not an option for low-cost passive UHF RFID tags. Modified RFID readers or special RFID tags can provide some marginal range improvement which is not very significant. Additionally, modifying any existing RFID system can be a costly and undesired option.

The read range of passive tags (tags without batteries) depends on many factors including the frequency of operation, the power of the reader, FCC restrictions, interference from metal objects or other RF devices, and chip sensitivity. The chip sensitivity threshold is the minimum received RF power necessary to turn on an RFID chip: the lower the sensitivity, the longer is the distance at which the tag can be detected.

### BRIEF DESCRIPTION OF THE DRAWINGS

FIG. 1A illustrates an example method for increasing tag range with an external power source.

FIG. 1B illustrates an example block diagram of a supplemental power source.

FIGS. 2A and 2B illustrate example arrangements of external power sources for increasing tag range.

FIG. 3 illustrates an experimental setup.

FIG. 4 illustrates an ISO/Gen2 RFI) tag tester.

FIG. 5A illustrates an example geometry of an ISO RFID tag.

FIG. 5B illustrates a plot of range vs. frequency with a power source ON and OFF.

FIG. 5C illustrates a plot of measured tag response.

FIG. 6A illustrates an example geometry of a Gen2 RFID tag.

FIG. 6B illustrates a plot of range vs. frequency with a power source ON and OFF.

FIG. 6C illustrates a plot of measured tag response.

FIG. 7 illustrates an example embodiment of a portable RFID read/write range booster.

FIG. 8 illustrates an example application for document tracking.

### DETAILED DESCRIPTION

In a broad sense, an apparatus and method for increasing the read/write range of a passive RFID device are disclosed in detail below.

The disclosed systems and methods provide a significant increase in the read/write range of existing RFID systems. Supplemental power is provided to the tag by employing an external RF wavelength power source. In some embodiments, the supplemental power source can be separate and independent from an RFID reader. The power source can operate on top of existing infrastructure with no interference. The systems and methods can work with any new or legacy RFID system, for any UHF frequency RFID band (e.g. 869 MHz, 915 MHz, 955 MHz) and any protocol (e.g. ISO, Class 0, Class 1, Gen 2). The systems and methods described herein can increase the range of any existing passive UHF RFID system without requiring any modification to the system itself.

Tag range can be extended by separating the energy needed to energize a tag with the reading of that tag. As a result, once a tag is energized, the only limitation on performance is whether the reader can read it. Because readers have sensitive receivers and are able to read faint tags, any compatible existing RFID reader and existing RFID tag can have a significantly improved range using these systems and methods.

As disclosed herein, the systems and methods method use one or more external supplemental power sources to provide supplemental RF power to the tag. This additional RF signal is converted by the front end of the tag chip to a DC voltage. This effectively lowers the chip sensitivity threshold across a wide band of frequencies, thereby increasing the tag read/write range. In some embodiments, the supplemental wavelength can be a substantially constant wavelength. In such embodiments, the wavelength can vary to a certain degree while remaining within a limited range of a predetermined wavelength. In other embodiments, the wavelength can be more precisely fixed at the predetermined wavelength. In other embodiments, more widely varying wavelengths and frequencies can be used (such as frequency hopping). In still further embodiments, combinations of constant and variable frequency and wavelength power sources can be used.

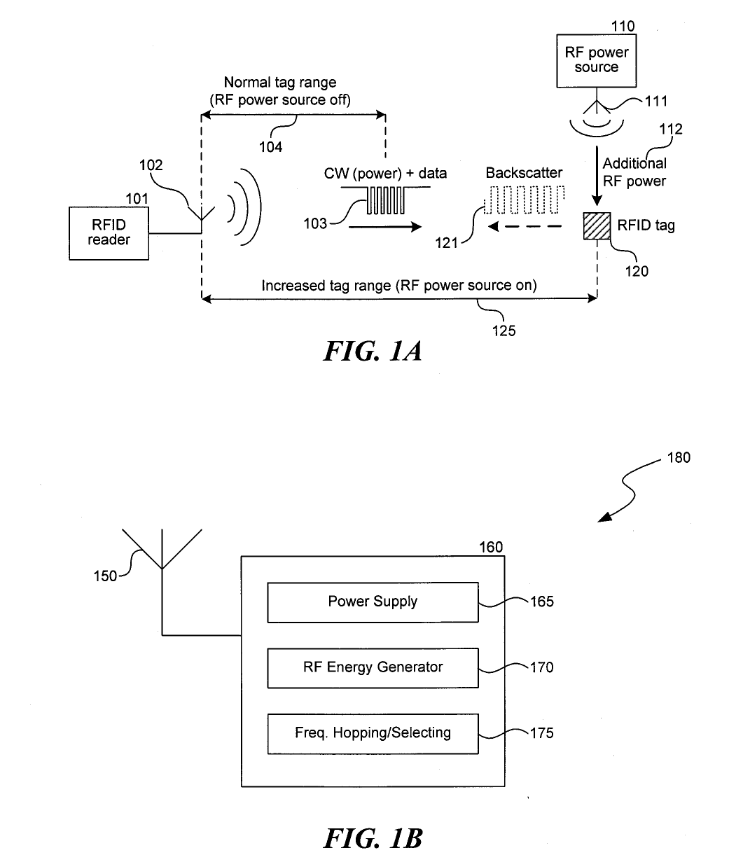

An example embodiment is illustrated in FIG. 1A. As illustrated, RFID reader 101 is coupled to antenna 102 and can transmit a power signal and data 103. Without the addition of supplemental power signal 112, the tag has read range 104. Supplemental power source 110 is coupled to an antenna 111 and can be used to transmit a supplemental power signal 112. RFID tag 120 can receive supplemental power signal 112 from power source 110 as well as power and data signal 103 from RFID reader 101. As a result, RFID tag 120 can generate a backscatter signal 121 which can be received over increased range 125.

In some embodiments, supplemental power sources can be provided in a two- or three-dimensional grid. In such an embodiment, some or all of the sources can be configured to operate at a relatively low power level so as to avoid FCC licensing requirements. Some grid arrangements can also employ frequency hopping where relatively high energy is transmitted but only for short bursts as the energizing source hops between frequencies. Several RF sources arranged in a grid can be used to cover a large area.

In some embodiments, the frequency hopping can be in the range of 902 to 928 megahertz, with the transmission being the carrier without any modulated information. In some embodiments, the supplemental power source includes no frequency stability or digital signal processing. In some embodiments, the supplemental power source can include modulated data.

In some embodiments, the supplemental power source can be separate and independent from an RFID reader. In other embodiments, the supplemental power source can be incorporated into an RFID reader. In many instances, the supplemental power source may be fixed relative to a given location. The location may be any stationary building or geographic space (such as a parking lot or park). Alternatively, the supplemental power source may be fixed relative to a movable object such as a vehicle (e.g., train, ship, or plane).

In some embodiments, the supplemental power source can be switched on or off mechanically (by an operator) or electronically (activated by RF signal, e.g. from an RFID reader). In some embodiments, the supplemental power source can be powered from a portable power source such as a car battery or other 12 V DC source or a 120 V AC voltage. In some embodiments, a 5V battery-powered design capable of producing up to 1 W RF output power can be based on RF Micro-Devices RF2131 power amplifier IC with a resonant feedback.

A block diagram of an example supplemental RF power source 180 is illustrated in FIG. 1B. The supplemental power source 180 can include an antenna 150, power supply 165, and RF energy generator 170. The supplemental power source 180 can also include optional frequency selection/hopping circuitry 175, in some embodiments.

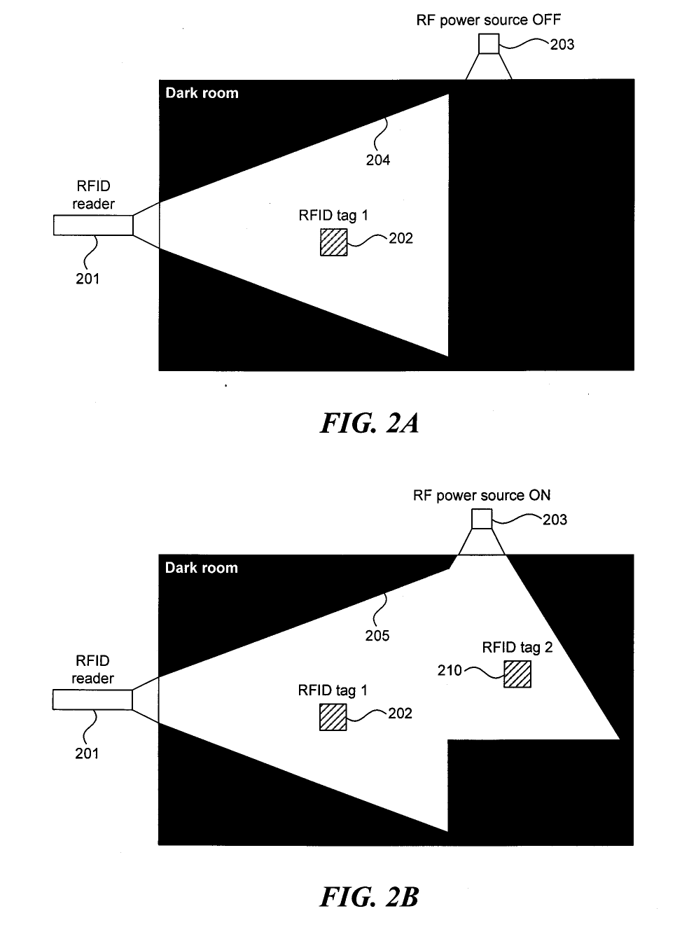

The effect of this method for increased tag range can also be illustrated using a dark room and flashlight analogy as shown in FIGS. 2A and 2B. While the supplemental power source described herein is not a flashlight, the source can have the effect of illuminating additional RFID tags. As illustrated in FIG. 2A, without the use of supplemental power source 203, RFID reader 201 illuminates a certain area 204 sufficient to illuminate RFID tag 1 202 in a ‘dark’ room. As illustrated in FIG. 2B, use of another source of light (supplemental power source 203) illuminates a larger area 205 and thereby allows an observer to ‘see’ other objects, such as RFID tag 2 210.

The amount of range increase depends, in part, on the power of the supplemental power source and its mutual position and orientation with respect to the tag. In some embodiments, passive UHF RFID tag range can increase up to 100 ft. (30 m) with a low power (e.g., 30 mW) RF power source transmitting at a distance from the tag.

### Experimental Results

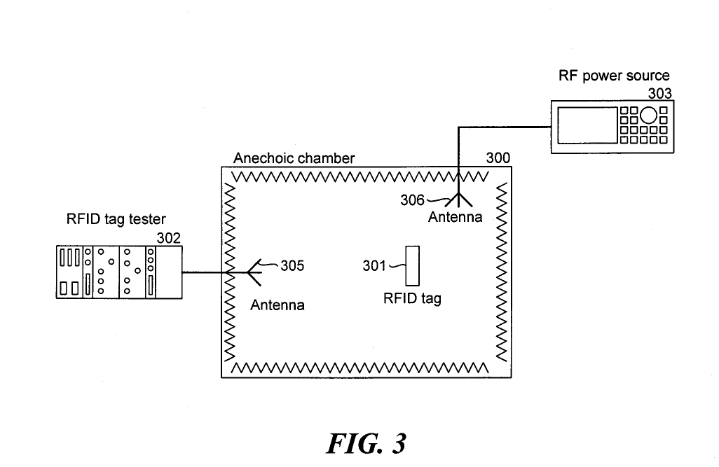

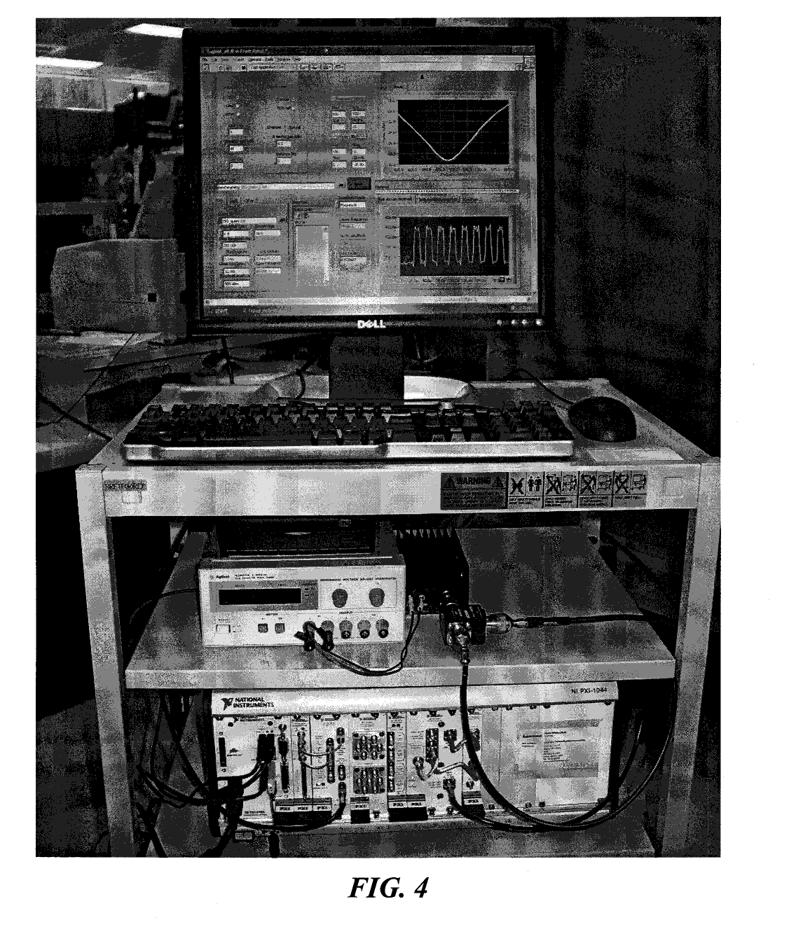

Measurements of several ISO and Gen2 RFID tags tuned to different resonant frequencies have been obtained using the systems and methods described herein. The measurements confirm an increase in observable range with the use of a supplemental power source. An experimental setup is illustrated in FIG. 3. RFID tag 301 was placed in anechoic chamber 300. RFID tag tester 302 was coupled to antenna 305 in chamber 300 and supplemental power source 303 was coupled to antenna 306 in chamber 300. In the setup, a stationary 30 mW RF supplemental power source 303 was connected to a dipole antenna 306 placed 2 ft. (0.61 m) away from tag 301. For tag range measurement, an Intermec new universal ISO/Gen2 RFID tag tester 302 was used. Tester 302 is shown in FIG. 4.

The tag testing setup shown in FIG. 4 was built on a modular hardware platform available from National Instruments, Austin, Tex., and has the same basic architecture as an RFID reader. It includes a PXI-5671 RF vector signal generator, a PXI-5660 RF signal analyzer, a PXI-8196 computer controller running National Instruments LabVIEW, a power amplifier, and a circulator. The LabVIEW application was used to generate query commands for RFID UHF tags operating under ISO and Gen2 protocols. The commands were sent at specified frequencies and the output power was increased until the tag response was detected. Tag range in free space can be calculated very accurately using this power level management.

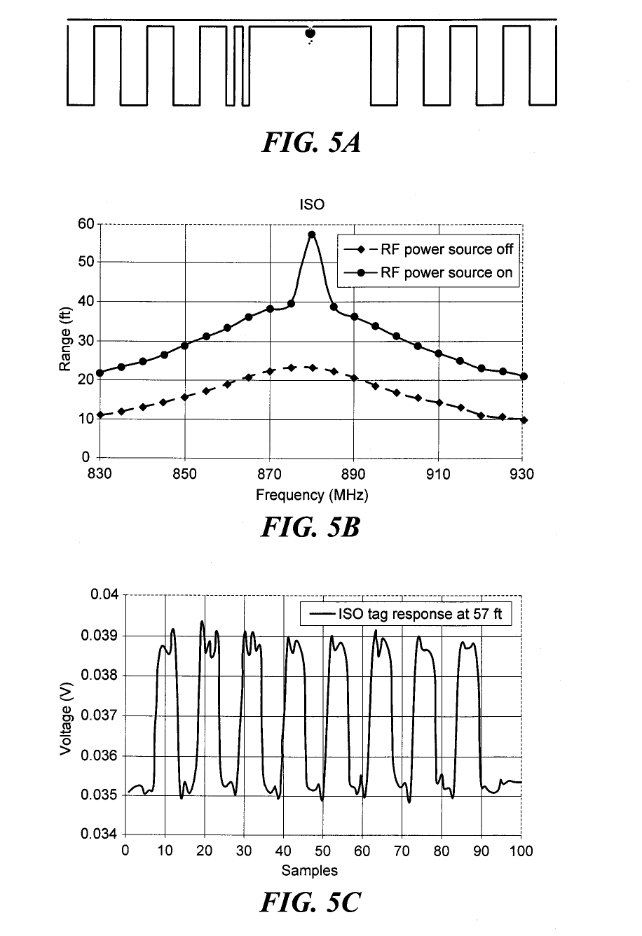

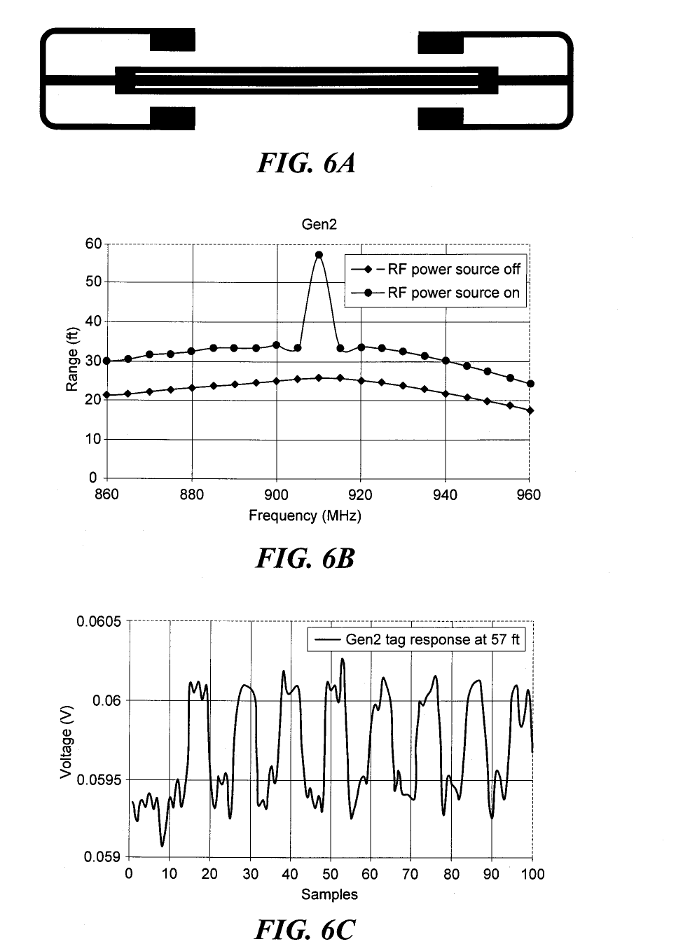

The results for two RFID tags are presented in FIGS. 5A-C and 6A-C. The ranges are for equivalent isotropic radiated power (EIRP) of 4 W. For an ISO tag such as the one shown in FIG. 5A, the measured range vs. frequency is shown in FIG. 5B and the tag response measured at the effective range of 57 ft. (17.4 m) is shown in FIG. 5C. An Intermec ISO meander tag tuned to 880 MHz (supplemental source was at 880 MHz) was used. For a Gen2 tag such as the one shown in FIG. 6A, the measured range vs. frequency is shown in FIG. 6B and the tag response measured at the effective range of 57 ft. (17.4 m) is shown in FIG. 6C. A KSW Gen2 harpoon tag tuned to 910 MHz (supplemental source was at 910 MHz) was used. The results indicate that even at distances of almost 60 ft. (18.3 m), the tag backscattered response is clearly readable and can be decoded with standard RFID readers. In some embodiments, a supplemental power source at frequencies other than tag resonant frequency can be used and results across the band of operation can be achieved.

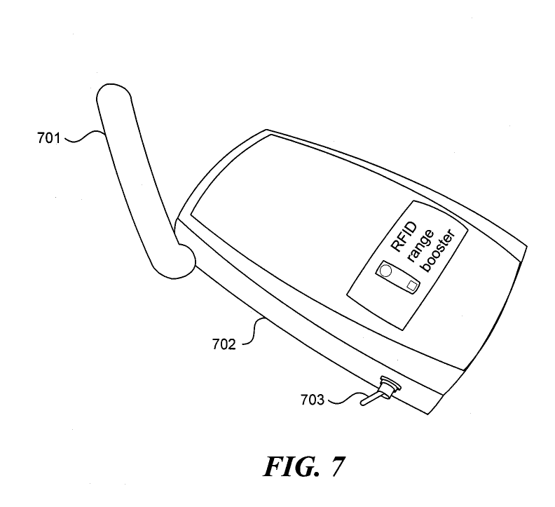

FIG. 7 illustrates an example of a portable external supplemental power source. As a non-limiting example, the supplemental power source can operate at 915 MHz with an output power of 1 W. As discussed above, other frequencies of operation are possible. In some embodiments, the supplemental power source can also be implemented based on a wireless 802.11 access point and provided as an additional optional feature of the access point. As illustrated, the supplemental power source can include antenna 701, body 702, and ON/OFF switch 703.

### Example Application

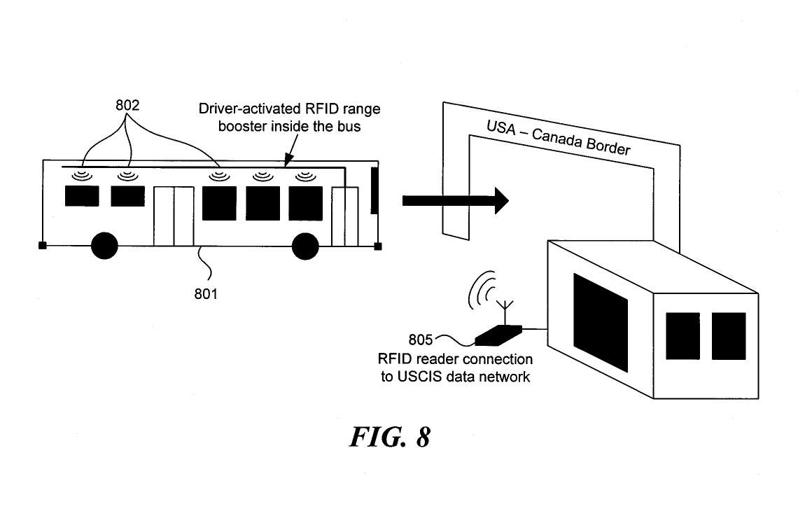

As non-limiting examples, these systems and methods can be used for passenger identification, tracking, and expedited passenger document checking at a border crossing. An example application for the systems and methods described herein is illustrated in FIG. 8. As illustrated, a supplemental power source can be used in connection with bus passenger border document tracking. Passenger documents (such as an I-94, passport, ticket, etc.) can be RFID enabled and used for tracking and identification while inside cars, buses, airplanes, and trains by governmental authorities.

A bus 801 crossing a border may contain people carrying RFID enabled documents. Without the use of the supplemental power source, because of the complex RF environment presented, the tags may not be energized and may therefore not visible to an interrogator. Using the systems and methods described herein, an operator of the bus 801 can enable one or more built-in supplemental power sources 802 to assist in making the RFID tags inside the bus visible to an interrogator with an RFID reader 805 outside the bus 801.

### CONCLUSION

Many specific details of certain embodiments of the invention are set forth in the description and in FIGS. 1-8 to provide a thorough understanding of these embodiments. A person skilled in the art, however, will understand that the invention may be practiced without several of these details or additional details can be added to the invention. Well-known structures and functions have not been shown or described in detail to avoid unnecessarily obscuring the description of the embodiments of the invention. As used herein, one or more components “coupled” to each other can be coupled directly (i.e., no other components are between the coupled components) or indirectly (i.e., one or more other components can be placed between the coupled components).

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined or altered to provide further embodiments.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein.

The terminology used in the Detailed Description is intended to be interpreted in its broadest reasonable manner, even though it is being used in conjunction with a detailed description of certain specific embodiments of the invention. Certain terms may even be emphasized; however, any terminology intended to be interpreted in any restricted manner will be overtly and specifically defined as such in this Detailed Description section. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as a means-plus-function claim under 35 U.S.C. sec. 112, other aspects may likewise be embodied as a means-plus-function claim. Accordingly, the inventors reserve the right to add additional claims after filing the application to pursue such additional claim forms for other aspects of the invention.

We claim:

1. An apparatus for increasing the range of a radio frequency identification (RFID) tag with respect to an RFID reader, wherein the RFID reader may provide a power signal to the RFID tag, the apparatus comprising:
a transmitter for transmitting a supplemental power signal to the RFID tag,
wherein the apparatus is separate and spaced apart from the RFID reader, and
wherein a frequency of the supplemental power signal is selected to cause the RFID tag to be energized and be read by the separate RFID reader.

2. The apparatus of claim 1, wherein the supplemental power signal is a carrier signal onto which no data is modulated.

3. The apparatus of claim 1, wherein the apparatus is stationary.

4. The apparatus of claim 1, wherein the transmitter is configured to transmit using frequency hopping.

5. The apparatus of claim 1, wherein the transmitter is fixed to a vehicle.

6. The apparatus of claim 1, wherein the transmitter is housed with a transmitter also configured to transmit an IEEE 802.11, IEEE 802.15, or IEEE 802.16 compliant signal.

7. The apparatus of claim 1, further comprising multiple transmitters for transmitting multiple supplemental power signals to an RFID tag, wherein the transmitters are arranged in a two-dimensional grid.

8. The apparatus of claim 1, further comprising multiple transmitters for transmitting multiple supplemental power signals to an RFID tag, wherein the transmitters are arranged in a three-dimensional space.

9. The apparatus of claim 1, further comprising an RF energy generator coupled to the transmitter.

10. The apparatus of claim 1, further comprising a selector for selecting the frequency of the supplemental power signal.

11. A method for increasing the range of a radio frequency identification (RFID) tag with respect to an RFID reader, wherein the RFID reader may provide a power signal to the RFID tag, the method comprising:
selecting a frequency of a supplemental power signal so as to cause the RFID tag to be energized and be read by the separate RFID reader; and
transmitting the supplemental power signal to the RFID tag from a transmitter that is separate and spaced apart from the RFID reader.

12. The method of claim 11, further comprising transmitting a data signal in a first frequency band and wherein the supplemental power signal is in a second frequency band.

13. The method of claim 12, wherein the first band and second band are different.

14. The method of claim 12, wherein the first band and second band are the same.

15. The method of claim 12, wherein the first band and second band substantially overlap.

16. The method of claim 11 further comprising transmitting the supplemental power signal using frequency hopping.

17. The method of claim 11, further comprising transmitting the supplemental power signal using a substantially constant wavelength.

18. The method of claim 11, further comprising transmitting multiple supplemental power signals from multiple transmission points.

19. The method of claim 11, further comprising transmitting the supplemental power signal from a source also configured to transmit an IEEE 802.11, IEEE 802.15, or IEEE 802.16 compliant signal.

20. The method of claim 11, wherein the supplemental power signal is a carrier signal onto which no data is modulated.

21. An apparatus for increasing the range of a radio frequency identification (RFID) tag with respect to an RFID reader, wherein the RFID reader may provide a power signal to the RFID tag, the apparatus comprising:
a means for transmitting a supplemental power signal to the RFID tag,
wherein the apparatus is separate and spaced apart from the RFID reader, and
wherein a frequency of the supplemental power signal is selected to cause the RFID tag to be energized and be read by the separate RFID reader.

22. The apparatus of claim 21, further comprising a means for transmitting the supplemental power signal using a substantially constant wavelength.
